(19) United States
(12) Patent Application Publication
(10) Pub. No.: US 2002/0169043 A1
(43) Pub. Date: Nov. 14, 2002

(54) Elliptic gearing for a bicycle

(76) Inventor: Chieh-I Liu, Taipei Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/139,259

(22) Filed: May 7, 2002

(30) Foreign Application Priority Data
May 10, 2001 (TW) 090207630

(51) Int. Cl. F16H 55/30; F16H 55/36; F16H 55/12

(52) U.S. Cl. 474/141; 474/160; 474/152

(57) ABSTRACT

An elliptic gearing for a bicycle has an elliptic driving gear rotatably mounted at a bottom-front end of a frame of the bicycle by a crank axle extending through the frame. A driven gear is rotatably mounted at a bottom-rear end of the frame. A chain connects the elliptic driving gear and the driven gear. Two cranks extend oppositely and are respectively mounted at two ends of the crank axle. The cranks are parallel to the maximum diameter of and perpendicular to the minimum diameter of the elliptic driving gear. Two pedals are pivotally mounted on distal ends of the cranks respectively. An adjusting device is mounted beneath the driven gear and connected to the driving and the driven gear by the chain.

### BACKGROUND OF THE INVENTION

1. Field of the Invention

The present invention is related to a bicycle, and more particularly an elliptic gearing for the bicycle.

2. Description of Related Art

In a conventional bicycle, the gearing for driving the bicycle generally has a circular driving gear, a driven gear and a chain connecting the driving gear and the driven gear. Two cranks and two pedals are respectively provided at two sides of the driving gear. When a user steps the pedals to rotate the driving gear, the driven gear is driven by the chain and the bicycle is moved forwards.

Because the driving gear is circular, the arm of force is the diameter of the driving gear and the moment for rotating the driving gear is constant. However, the rotational motion of the rider's feet means that force turning the driving gear is not constant. That is at lowermost and uppermost points of the rotational motion of the two pedals the rider is substantially pushing the pedals forward and backward until the full weight and strength of the rider is exerted on the pedals as the cranks become parallel to the ground. The circular driving gear does not efficiently utilize the maximum available force. Therefore, the invention provides an elliptic gearing for a bicycle to mitigate and/or obviate the aforementioned problems.

### SUMMARY OF THE INVENTION

The main objective of the invention is to provide an elliptic gearing for a bicycle that provides a special exercise effect for a user.

Another objective of the invention is to provide an elliptic gearing for a bicycle that make the user feel joys in riding. Other objects, advantages and novel features of the invention will become more apparent from the following detailed description when taken in conjunction with the accompanying drawings.

### BRIEF DESCRIPTION OF THE DRAWINGS

FIG. 1 is a front view of a gearing for a bicycle in accordance with the invention;

FIG. 2 is a front view of the gearing of the invention when cranks are horizontal;

FIG. 3 is a front view of the gearing of the invention when the cranks are at a certain position; and

FIG. 4 is a front view of the gearing of the invention when the cranks are vertical.

### DETAILED DESCRIPTION OF THE PREFERRED EMBODIMENT

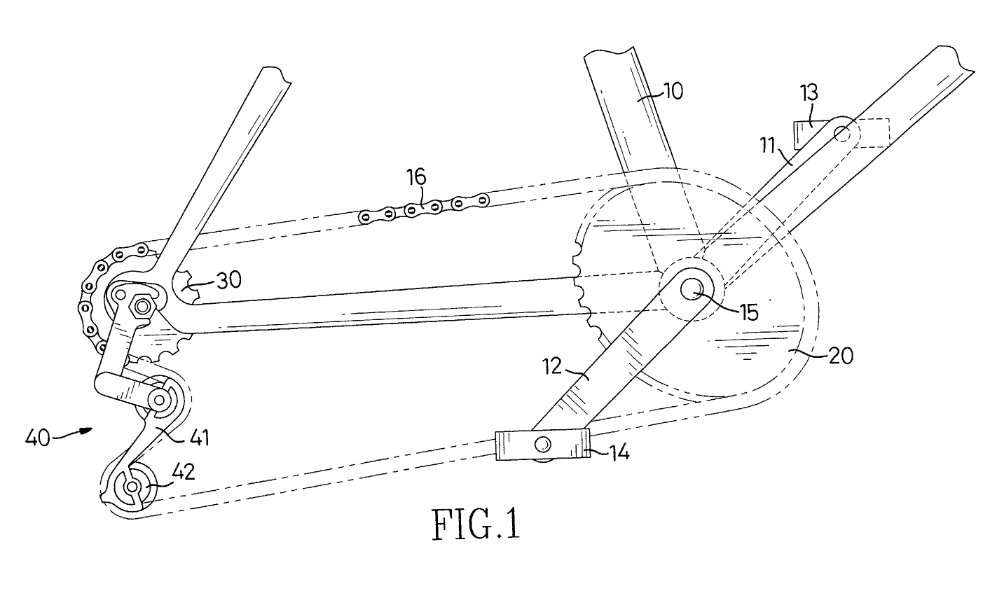

Referring to FIG. 1, a gearing in accordance with the invention is mounted on a frame (10) of a bicycle. The gearing has an elliptic driving gear (20) is rotatably mounted at a bottom-front end of the frame (10) by a crank axle (15) extending through the frame (10). Two cranks (11, 12) are respectively mounted at two sides of the crank axle (15) and extend oppositely. Two pedals (13, 14) are pivotally mounted at distal ends of the cranks (11, 12) respectively.

A driven gear (30) is rotatably mounted at a bottom-rear end of the frame (10) and at a center of a rear wheel (not shown or numbered) of the bicycle. An adjusting device (40) is mounted beneath the driven gear (30). The adjusting device (40) has an arm (41) and two tension wheels (42) mounted at upper and lower ends of the arm (41). The upper tension wheel (42) is rotatably mounted on a bracket (not numbered) secured on the frame (10), so that the arm (41) is able to pivot about the bracket.

A chain (16) in turn passes the driving gear (20), the driven gear (30), the upper tension wheel (42), the lower tension wheel (42), and returns to the driving gear (20) to connect these elements together.

According to the invention, the cranks (11, 12) are in line across the minimum diameter of the elliptic gear (20) and perpendicular to the maximum diameter of the elliptic gear (20).

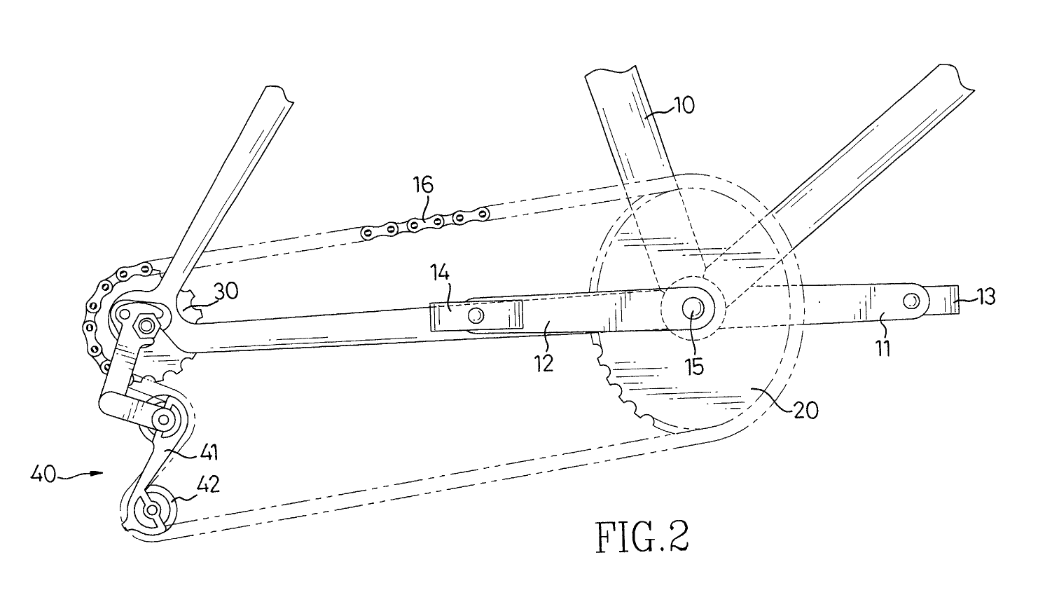

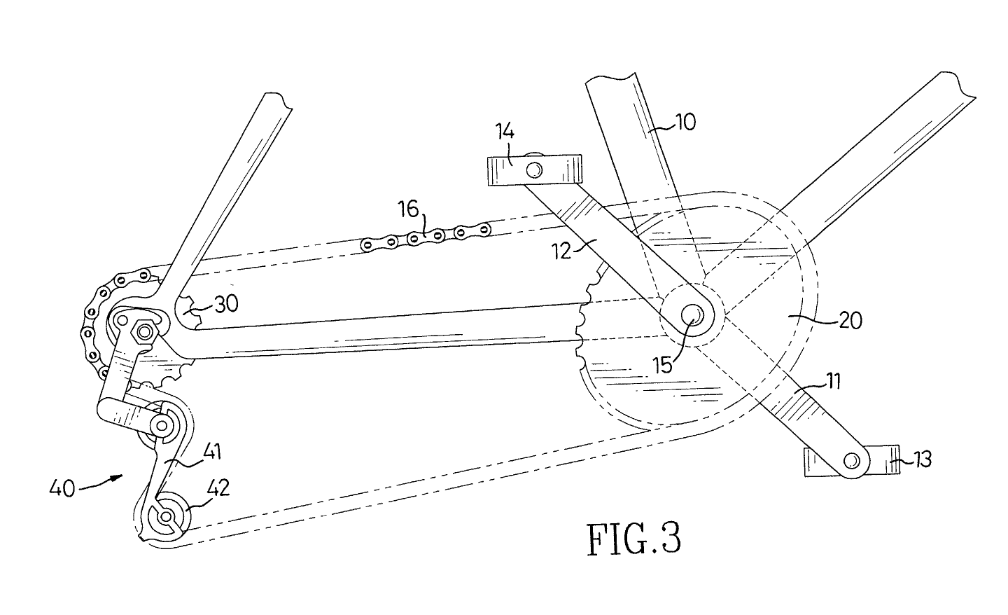

Referring to FIGS. 2-4, when the cranks (11, 12) are horizontal as shown in FIG. 82, the maximum diameter of the elliptic gear (20) is vertical as the arm of force. In this position, the driving gear (20) can get the largest moment. At the same time, the first pedal (13) is located at the forefront position which is most easy for a user to step. Therefore, the 0-90° course of the driving gear (20) between the vertical position to the horizontal position of the maximum diameter is the most efficient.

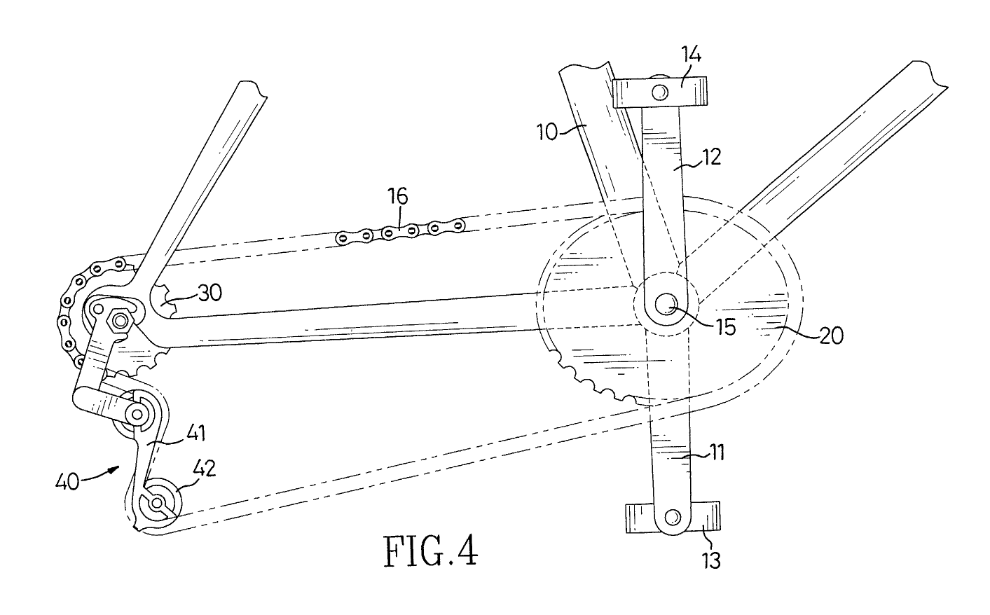

When the cranks (11, 12) are vertical as shown in FIG. 4, the minimum diameter of the elliptic gear (20) is vertical as the arm of force. In this position, the moment of the driving gear (20) is the least efficient. At the same time, the first pedal (13) is located at the lowest position which is difficult for the user to step. Therefore, the 90°-180° course of the driving gear (20) between the vertical position to the horizontal position of the minimum diameter is inefficient. However, under the effect of inertia, the driving gear (20) also can be rotated continuously.

When the maximum diameter of the gear (20) is vertical again after the gear (20) turns 180°, the driving gear (20) can get the largest moment, and the second pedal (14) is located at the forefront position which is most easy for a user to step on. Therefore, the 180°-270° course of the driving gear (20) is also efficient.

Similar to the 90°-180° course, the 270°-360° course of the driving gear (20) is inefficient.

In the rotation, the arm (41) of the adjusting device (40) can be pivoted to ensure that the chain (16) is tightly engaged with the driving gear (20) and the driven gear (30).

According to the invention, the downward force as the rider pushes each pedal directly downward is maximized by the elliptical gear (20), and the point where the pedals shift from uppermost point to lowermost point and vice-versa has a minimized force requirement. Thus, the rider can travel faster and/or further than with a connventional circular chainwheel. It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An elliptic gearing for a bicycle, comprising:
an elliptic driving gear (20) rotatably mounted at a bottom-front end of a frame (10) of the bicycle by a crank axle (15) extending through the frame (10);
a driven gear (30) rotatably mounted at a bottom-rear end of the frame (10);
a chain (16) connecting the elliptic driving gear (20) and the driven gear (30),
two cranks (11, 12) extending oppositely and respectively mounted at two ends of the crank axle (15), the cranks (11, 12) parallel to the maximum diameter of, and perpendicular to the minimum diameter of the elliptic driving gear (20);
two pedals (13, 14) pivotally mounted on distal ends of the cranks (11, 12) respectively; and
an adjusting device (40) mounted beneath the driven gear (30) and connected to the driving (20) and the driven gear (30) by the chain (16).

2. The elliptic gearing as claimed in claim 1, wherein the adjusting device (40) has an arm (41) pivotally mounted on a bracket secured on the frame (10), and two tension wheels (42) pivotally mounted at upper and lower ends of the arm (41) respectively.

3. The elliptic gearing as claimed in claim 2, wherein the chain (16) passes an inside of the upper tension wheel (42) and an outside of the lower tension wheel (42).
